(19) United States
(12) Patent Application Publication
(10) Pub. No.: US 2005/0114523 A1
(43) Pub. Date: May 26, 2005

(54) Computer-implemented method, system and program product for providing real-time access to information on a computer system over a network

(75) Inventors: John W. Barron, Berthoud, CO (US); Anthony Bernal, Houston, TX (US); Shandrof Burks JR., Spring, TX (US); Ian R. Uriarte, Houston, TX (US)

Correspondence Address: HOFFMAN WARNICK & D'ALESSANDRO, LLC, 3 E-COMM SQUARE, ALBANY, NY, 12207, US

(73) Assignee: International Business Machines Corporation, Armonk, NY (US)

(21) Appl. No.: 10/723,115

(22) Filed: Nov. 26, 2003

(51) Int. Cl. G06F 15/16

(52) U.S. Cl. 709/228

(57) ABSTRACT

Under the present invention, user interface pages are served to a user so that the user can access “information” files in real-time using a web browser or the like. In a typical embodiment, the user will input login data, which will be used to access his/her access control permissions. Based on the access control permissions, the files the user is authorized to access will be displayed in a list along with a list of links to other computer systems in the network the user can access. When the user selects a desired file, that file will be retrieved in real-time and the information therein will be communicated to the user for viewing in the interface pages.

### BACKGROUND OF THE INVENTION

1. Field of the Invention

In general, the present invention comprises a computer-implemented method, system and program product for providing real-time access to information on a computer system over a network. Specifically, the present invention allows a user such as a developer to access computer log files or the like in real-time from a remote location.

2. Related Art

As computer technology becomes more pervasive, it has become common for businesses and other organizations to implement their Information Technology (IT) solutions in a distributed environment. As such, an organization's computing infrastructure may include numerous servers and clients arranged in different geographical locations throughout the world. When implementing such an infrastructure, it is often desirable for developers, administrators or the like to access certain pieces of information to gauge the performance and usage of the system. For example, a developer might desire access to certain types of files such as log files, properties files, configuration files, etc. so he/she can view pertinent information.

To date, accessing such information has been a localized process. Specifically, if a developer wishes to view this information for a specific machine in the system, he/she will directly access the specific machine and then the corresponding files. Unfortunately, such a process can raise various concerns. For example, in accessing a specific machine, the developer might also gain access to information for which he/she is not authorized. Moreover, the developer might attempt to make certain changes that are not desired by an administrator. Accordingly, by allowing a developer to access a machine directly, access control could become difficult. Other solutions have been suggested in which such files are exported or saved to a remote location where they can be accessed by the appropriate parties. Although this scenario helps increase access control to the machines themselves, they often fail to provide up to date information. Specifically, by the time the files are exported and accessed, the information therein is old. Since it is often the desire of developers to access the information in real-time, the current system of exporting/saving the files to another location can be insufficient.

In view of the foregoing, there exists a need for a way to provide real-time access to information on a computer system over a network (i.e., from a remote location). Specifically, a need exists whereby developers or the like can access log files, properties files, configuration files and the like in real-time from locations that are remote from the computer systems on which the files are stored.

### SUMMARY OF THE INVENTION

In general, the present invention provides a computer-implemented method, system and program product for providing real-time access to information on a computer system over a network (i.e., remotely). Specifically, under the present invention, user interface pages are served to a user interface so that the user can access “information” files in real-time using a web browser or the like. In a typical embodiment, the user will input login data, which will be used to access his/her access control permissions. Based on the access control permissions, the files the user is authorized to access will be displayed in a list along with a list of links to other computer systems in the network the user can access. When the user selects a desired file, that file will be retrieved in real-time and the information therein will be communicated to the user for viewing in the interface pages. In communicating the information to the user, the present invention could extract the information, or it could communicate/download the entire file to the user's computer system. In any event, the user can also be provided with the capability to search a file, or select a particular location within a file from which he/she desires to view information.

A first aspect of the present invention provides a computer-implemented method for providing real-time access to information on a computer system over a network, comprising: receiving login data on the computer system from a user over the network; retrieving access control permissions for the user based on the login data; presenting to the user in a user interface a list of files on the computer system the user is authorized to access, wherein the list of files is determined based on the access control permissions; receiving from the user a selection of a desired file from the list of files; and retrieving the desired file in real-time and communicating information in the desired file to the user.

A second aspect of the present invention provides a computer-implemented method for providing real-time access to information on a computer system over a network, comprising: receiving login data from a user on one of a plurality of interconnected computer systems over the network; retrieving access control permissions for the user based on the login data; presenting to the user in a user interface a list of files on the one of the plurality of interconnected computer systems the user is authorized to access, and a list of links to other computer systems in the plurality of interconnected computer systems, wherein the list of files is determined based on the access control permissions; receiving a selection of a desired file from the user; and retrieving the desired file in real-time from a corresponding one of the plurality of interconnected computer systems and communicating information in the desired file to the user.

A third aspect of the present invention provides a computerized system for providing real-time access to information on a computer system over a network, comprising: an interface system for serving interface pages over the network from a computer system to a user system; a login system for receiving login data from a user operating the user system and for retrieving access control permissions for the user based on the login data; a file display system for presenting to the user in the interface pages a list of files on the computer system the user is authorized to access, wherein the list of files is determined based on the access control permissions; a selection system for receiving from the user a selection of a desired file from the list of files; and a file retrieval system for retrieving the desired file in real-time and for communicating information in the desired file to the user.

A fourth aspect of the present invention provides a program product stored on a recordable medium for providing real-time access to information on a computer system over a network, which when executed, comprising: program code for serving interface pages over the network from a computer system to a user system; program code for receiving login data from a user operating the user system and for retrieving access control permissions for the user based on the login data; program code for presenting to the user in the interface pages a list of files on the computer system the user is authorized to access, wherein the list of files is determined based on the access control permissions; program code for receiving from the user a selection of a desired file from the list of files; and program code for retrieving the desired file in real-time and for communicating information in the desired file to the user.

Therefore, the present invention provides a computer-implemented method, system and program product for providing real-time access to information on a computer system over a network (i.e., remotely).

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative architecture for implementing the present invention.

FIG. 2 depicts the illustrative architecture of FIG. 1 in greater detail.

FIG. 3 depicts a first user interface page according to the present invention.

FIG. 4 depicts a second user interface page according to the present invention.

FIG. 5 depicts a third user interface page according to the present invention.

FIG. 6 depicts a fourth user interface page according to the present invention.

FIG. 7 depicts a method flow diagram according to the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a computer-implemented method, system and program product for providing real-time access to information on a computer system over a network (i.e., remotely). Specifically, under the present invention, user interface pages are served to a user interface so that the user can access “information” files in real-time using a web browser or the like. In a typical embodiment, the user will input login data, which will be used to access his/her access control permissions. Based on the access control permissions, the files the user is authorized to access will be displayed in a list along with a list of links to other computer systems in the network the user can access. When the user selects a desired file, that file will be retrieved in real-time and the information therein will be communicated to the user for viewing in the interface pages. In communicating the information to the user, the present invention could extract the information, or it could communicate/download the entire file to the user's computer system. In any event, the user can also be provided with the capability to search a file, or select a particular location within a file from which he/she desires to view information. Among other things, the present invention isolates the user from the operating system of the individual computer systems. That is, the user need only know how to navigate about the provided interface pages.

It should be understood that the files referred to herein typically contain information about the operation or usage of a particular computer system. For example, the files could be log files, properties files, configuration files, etc. Moreover, the files will typically be stored locally on the respective computer system (although this need not be the case).

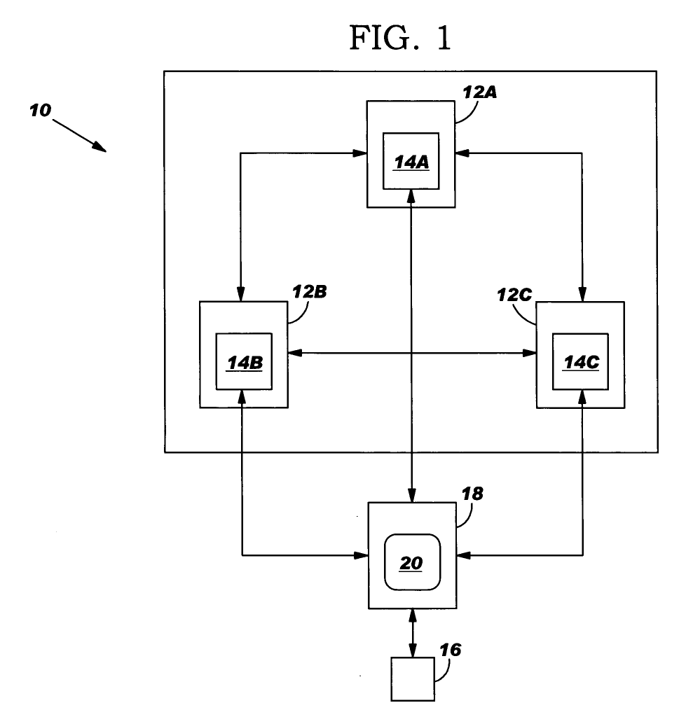

Referring now to FIG. 1, an illustrative computer architecture 10 is shown. In general, architecture 10 includes one or more computer systems 12A-C that are interconnected in a distributed environment. Computer systems 12A-C typically represent servers or possibly clients that are positioned in different geographic locations within a network. As such, the network could be any type of network such as a local area network (LAN), a wide area network (WAN), a virtual private network (VPN), etc. Under the present invention, user 16 operating a user system 18 (e.g., a personal computer, a laptop, a handheld device, etc.) will remotely access information files on any of computer systems 12A-C in real-time (i.e., over a network such as the Internet) in a client-server or server-server environment. Communication between computer systems 12A-C and/or user system 18 could occur via a direct hardwired connection (e.g., serial port), or via an addressable connection that may utilize any combination of wireline and/or wireless transmission methods. Systems 12A-C and 18 may utilize conventional network connectivity, such as Token Ring, Ethernet, WiFi or other conventional communications standards. Moreover, connectivity could be provided by conventional TCP/IP sockets-based protocol. In a typical embodiment, user system 18 is a client or a server that utilizes an Internet service provider to establish connectivity to computer systems 12A-C.

Regardless, user 16 will operate user interface 20 (e.g., a web browser) on user system 18 to establish connectivity to one of the computer systems 12A-C. Once connectivity is established, the corresponding information access system 14A-C will serve a set of interface pages to user interface 20 that provides access control, and allows user to specifically select a file and/or information within a file he/she wishes to view in real-time. It should be understood in advance that although in a typical embodiment, user interface 20 is a web browser, it could actually be any type of user interface that fosters communication over a network. That is, the present invention could be implemented over any type of network, and is not limited to the Internet.

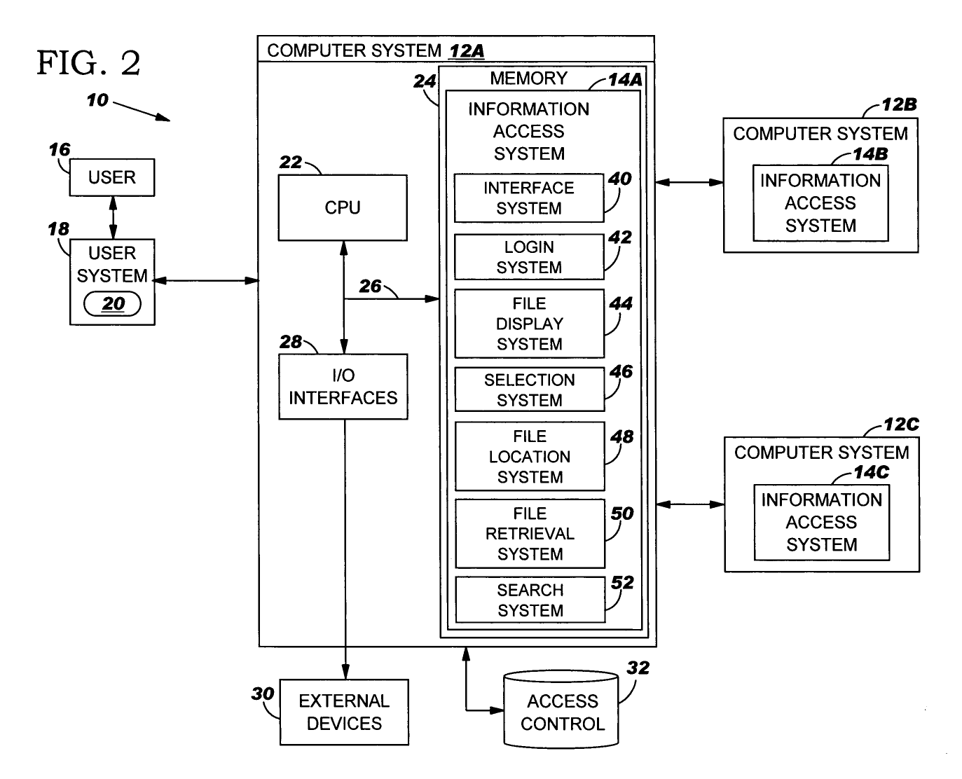

Referring now to FIG. 2, a more detailed diagram of architecture 10 is shown. In the diagram shown in FIG. 2, it is assumed that user 16 is directly accessing computer system 12A. As depicted, computer system 12A generally comprises central processing unit (CPU) 22, memory 24, bus 26, input/output (I/O) interfaces 28, external devices/resources 30 and storage unit 32. CPU 22 may comprise a single processing unit, or be distributed across one or more processing units in one or more locations, e.g., on a client and server. Memory 24 may comprise any known type of data storage and/or transmission media, including magnetic media, optical media, random access memory (RAM), read-only memory (ROM), a data cache, etc. Moreover, similar to CPU 22, memory 24 may reside at a single physical location, comprising one or more types of data storage, or be distributed across a plurality of physical systems in various forms.

I/O interfaces 28 may comprise any system for exchanging information to/from an external source. External devices/resources 30 may comprise any known type of external device, including speakers, a CRT, LCD screen, handheld device, keyboard, mouse, voice recognition system, speech output system, printer, monitor/display, facsimile, pager, etc. Bus 26 provides a communication link between each of the components in computer system 12A and likewise may comprise any known type of transmission link, including electrical, optical, wireless, etc.

Storage unit 32 can be any system (e.g., database) capable of providing storage for information under the present invention. Such information could include, for example, access control permissions for users. As such, storage unit 32 could include one or more storage devices, such as a magnetic disk drive or an optical disk drive. In another embodiment, storage unit 32 includes data distributed across, for example, a local area network (LAN), wide area network (WAN) or a storage area network (SAN) (not shown). Furthermore, although not shown, additional components, such as cache memory, communication systems, system software, etc., may be incorporated into computer system 12A. In addition, it should be appreciated that although not shown, computer systems 12B-C and user system 18 would likely include computerized components similar to computer system 12A. Such components have not been shown for brevity purposes.

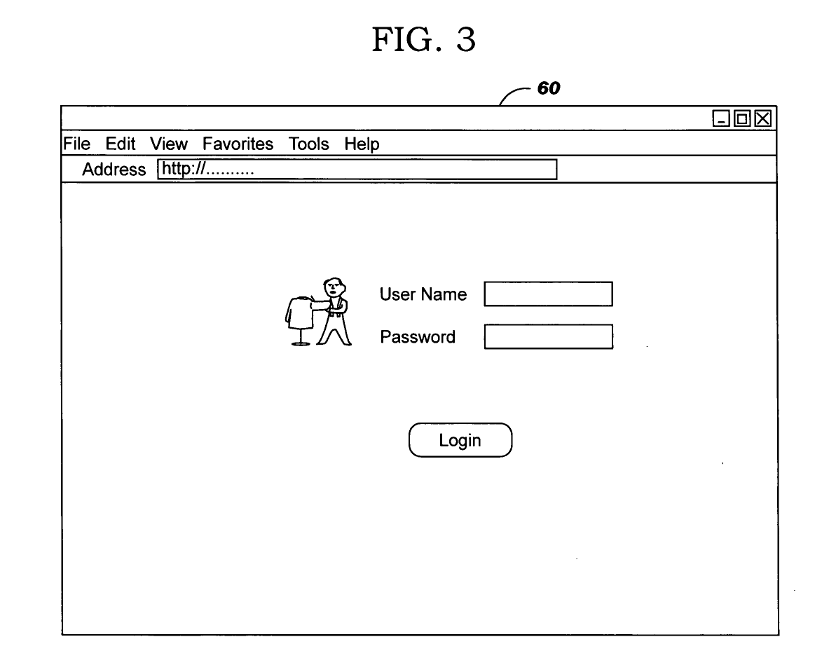

In any event, to directly access computer system 12A, user 16 will input an address (e.g., a URL) corresponding to computer system 12A via user interface 20. Upon so doing, interface system 40 of information access system 14A will serve the first of a set of interface pages (each of which can be customized/configured by an administrator or the like) to user interface 20. Referring to FIG. 3, an illustrative interface page 60 is shown. As depicted, interface page 60 is a login page into which user 16 will input login data such as a user name and password. Referring back to FIG. 2, the login data will be received by login system 42 which will consult access control permissions. The access control permissions can be stored locally on each computer system 14A-C such as in storage unit 32, or they can be provided at a single location accessible to all computer systems 14A-C. Regardless, the access control permissions set forth the specific files on computer system 12A, as well as the files on the other computer systems 12B-C that user 16 is authorized to access. In a typical embodiment, the access control permissions are prepared in advance by an administrator or the like. Moreover, the interface pages could be generated by interface system 40 from a template (e.g., as stored in storage unit 32), or could be prepared in advance by the administrator and stored.

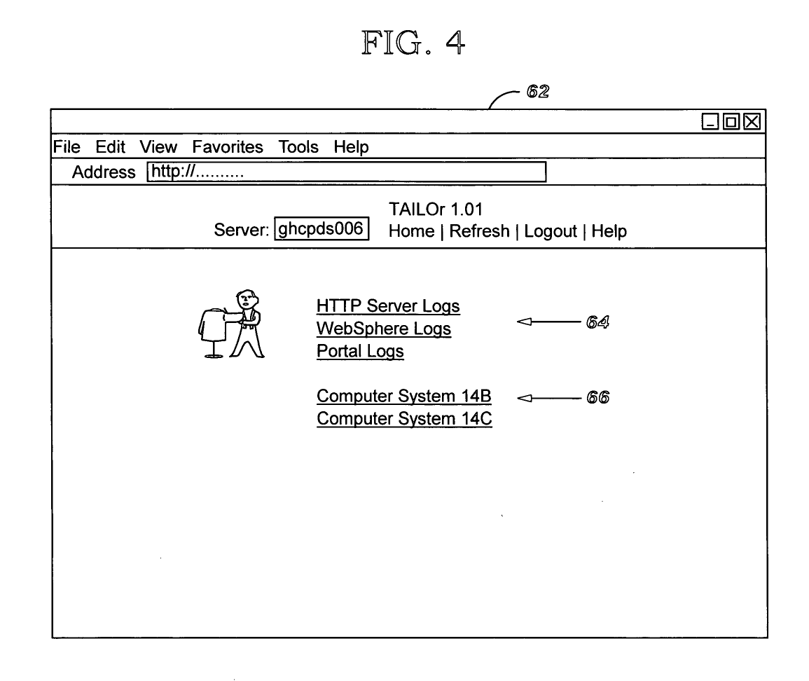

Once the access control permissions are determined, file display system 44 will display the list of files along with links to other computer systems 12B-C in a file interface page that is served to user interface 20 via interface system 40. Referring to FIG. 4, an illustrative file interface page 62 is depicted. As shown, user 16 is provided with three options in a list of file types 64. Namely, user 16 can access HTTP Server Log files, WebSphere Log Files or Portal log files on computer system 12A. Also, user 16 is provided with links 66 to computer systems 12B-C. User 16 can select a desired file type displayed in list of file types 64 (e.g., by clicking on it). Alternatively, user 16 can select another computer system 12B-C and be presented with a list of files thereon from which user 16 can select. Assuming user 16 selected a file in list 64, that selection will be received by selection system 46. Based thereon, file display system 44 will display all corresponding files in a subsequent file interface page that is served by interface system 40.

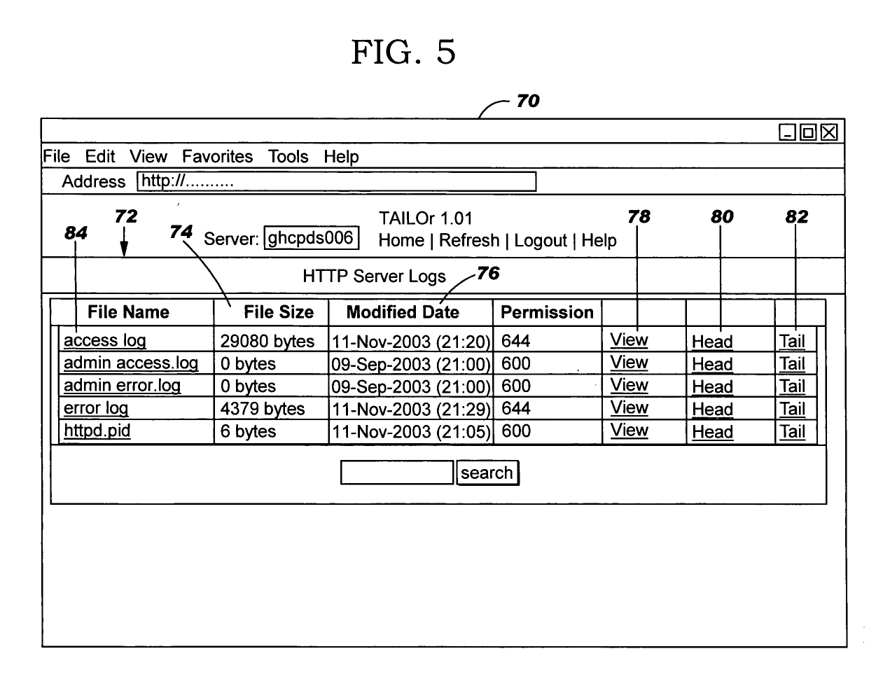

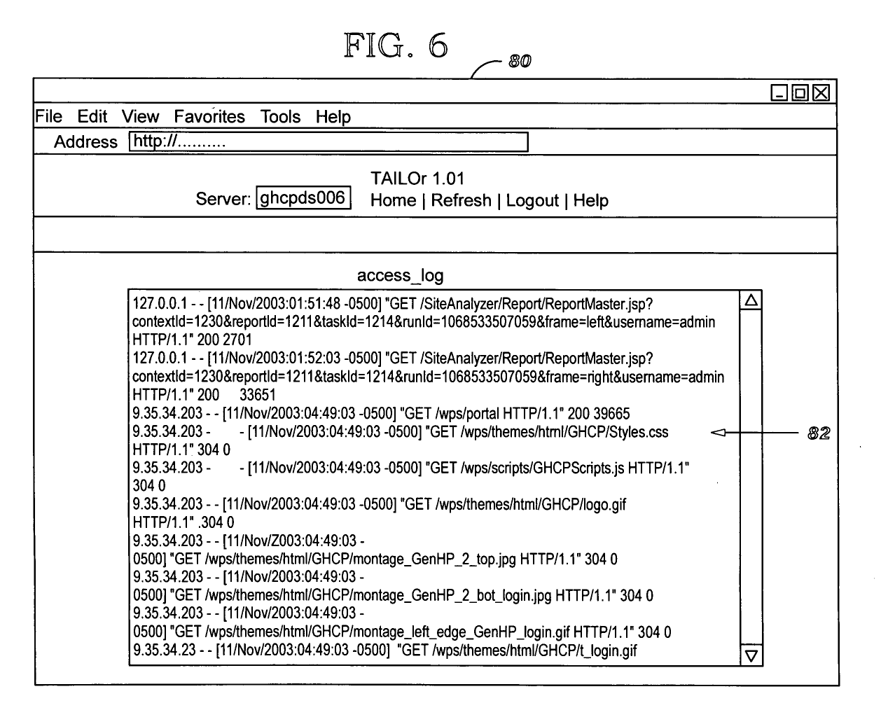

Referring to FIG. 5, such an illustrative interface page 70 is shown. FIG. 5 assumes that user 16 selected the HTTP Server Log file type in FIG. 4. As depicted, a list of files 72 is displayed along with corresponding descriptive data such as the file size 74 and modified date 76. User 16 can select a desired file by selecting it's corresponding view button/link 78. That selection will be received by selection system 46 (FIG. 2). Upon receipt, file location system 48 (FIG. 2) will locate the desired file on computer system 12A (e.g., in memory 24, storage unit 32, etc.) for retrieval by file retrieval system 50 (FIG. 2) in real-time. The information within the file will then be instantly communicated to user 16 (e.g., by file retrieval system 50) for display in an information interface page that is served by interface system 40. Referring to FIG. 6, an illustrative information interface page 80 is shown. As depicted, the information 82 within the file is provided to user 16 for review. Since the file is both retrieved/accessed and communicated to user 16 in real-time, the information therein is current. It should be understood that in providing the information within a selected file to user 16, file retrieval system 50 could extract the information therein for communication to user interface 20, or the entire file could be communicated/downloaded to user system 18.

In any event, referring back to FIG. 5, interface page 70 also includes head buttons/links 80 and tail buttons/links 82. These buttons allow user 16 to select a particular location in a desired file from which information is sought. For example, if user 16 selected the head button/link 80 for accessing log file 84, the selection would be received by selection system 46 and file retrieval system 50 would retrieve only the information in the beginning of the access log file 84. Similarly, if user 16 selected the tail button/link 82, only the information from the end of the file would be retrieved. Thus, user 16 can select specific locations of a file for viewing information. In determining the quantity of information that represents a beginning or end of a file, any algorithm could be implemented. For example, file retrieval system 50 could retrieve a fixed quantity of lines of information from the beginning or end of the file. Alternatively, file retrieval system 50 could retrieve certain percentage of information. For example, file retrieval system 50 could retrieve the first 25% of lines of information for a head button/link 80 selection and the last 25% of lines for a tail button/link 82 selection.

Referring back to FIG. 2, information access system 14A further includes a search system 52 that allows user 16 to search a file for particular key words or the like. In one embodiment, user can selected a “search” button on one of the interface pages. Thereafter, a search interface page can be displayed for user 16 to input keywords. The keywords will be received by search system 52, which will conduct a search of a selected file. For example, assume that user 16 had selected access file 84 in interface page 70 of FIG. 5. When the information is displayed, user 16 can then decide to search the information for specific keywords.

It should be understood that the present invention can be realized in hardware, software, or a combination of hardware and software. Any kind of computer system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

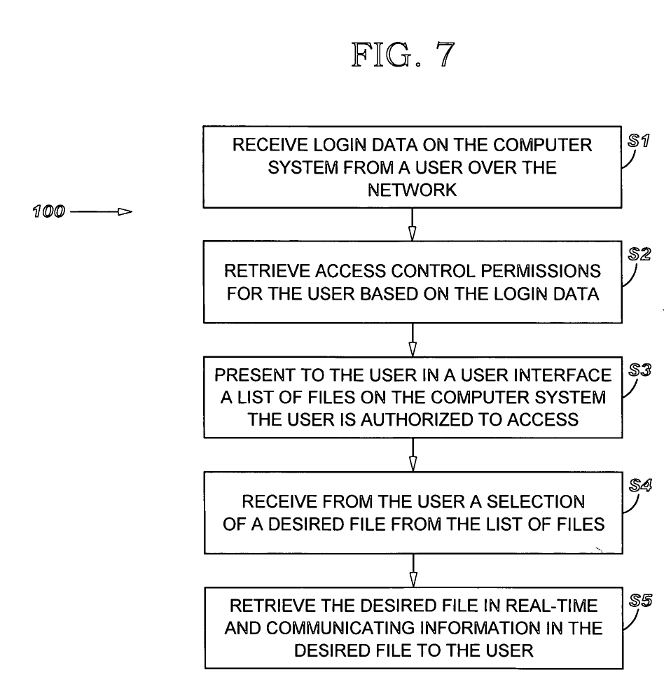

Referring now to FIG. 7, a method flow diagram 100 according to the present invention is shown. As depicted, first step S1 of the method is to receive login data on the computer system from a user over the network. Second step S2 is to retrieve access control permissions for the user based on the login data. Third step S3 is to present to the user in a user interface a list of files on the computer system the user is authorized to access. As indicated above, the list of files is determined based on the access control permissions. Fourth step S4 is to receive from the user a selection of a desired file from the list of files. Fifth step S5 is to retrieve the desired file in real-time and communicating information in the desired file to the user.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims. For example, the depiction of information access system 14A of FIG. 2 is intended to be illustrative only. To this extent, the functions described herein could be implemented in a different quantity of subsystems. Moreover, some the systems could have overlapping functions. For example, the information within a selected file could be displayed in information interface page 80 by file display system 44, as opposed to file retrieval system 50. Stilly yet, the functions of file location system 48 and file retrieval system 50 could be provided within a single subsystem.

1. A computer-implemented method for providing real-time access to information on a computer system over a network, comprising:
receiving login data on the computer system from a user over the network;
retrieving access control permissions for the user based on the login data;
presenting to the user in a user interface a list of files on the computer system the user is authorized to access, wherein the list of files is determined based on the access control permissions;
receiving from the user a selection of a desired file from the list of files; and
retrieving the desired file in real-time and communicating information in the desired file to the user.

2. The computer-implemented method of claim 1, wherein the network is the Internet, and wherein the user interface is a web browser.

3. The computer-implemented method of claim 1, wherein the list of files contains at least one file type selected from the group consisting of a properties file, a configuration file and a log file.

4. The computer-implemented method of claim 1, further comprising receiving from the user a selection of a particular location within the desired file, wherein the information communicated to the user is from the particular location.

5. The computer-implemented method of claim 1, further comprising the user searching the information using the user interface.

6. The computer-implemented method of claim 1, wherein the computer system is one of a plurality of computer systems interconnected in a distributed environment.

7. The computer-implemented method of claim 1, wherein the files in the list of files are stored on the computer system.

8. The computer-implemented method of claim 1, the information in the file is communicated to the user interface for display.

9. The computer-implemented method of claim 1, wherein communicating the information in the desired file comprises downloading the desired file to the user for display of the information within the user interface.

10. A computer-implemented method for providing real-time access to information on a computer system over a network, comprising:
receiving login data from a user on one of a plurality of interconnected computer systems over the network;
retrieving access control permissions for the user based on the login data;
presenting to the user in a user interface a list of files on the one of the plurality of interconnected computer systems the user is authorized to access, and a list of links to other computer systems in the plurality of interconnected computer systems, wherein the list of files is determined based on the access control permissions;
receiving a selection of a desired file from the user; and
retrieving the desired file in real-time from a corresponding one of the plurality of interconnected computer systems and communicating information in the desired file to the user.

11. The computer-implemented method of claim 10, wherein the network is the Internet, and wherein the user interface is a web browser.

12. The computer-implemented method of claim 10, wherein the list of files contains at least one file type selected from the group consisting of a properties file, a configuration file and a log file.

13. The computer-implemented method of claim 10, further comprising receiving from the user a selection of a particular location within the desired file, wherein the information communicated to the user is from the particular location.

14. The computer-implemented method of claim 10, further comprising the user searching the information using the user interface.

15. The computer-implemented method of claim 10, wherein the corresponding one of the plurality of interconnected computer systems is the one of the plurality of interconnected computer systems on which the login data is received.

16. The computer-implemented method of claim 10, further comprising:
receiving a selection of a link in the list of links after the presenting step;
accessing another one of the plurality of interconnected computer systems based on the selection of the link; and
presenting to the user a new list of files the user is authorized to access on the other one of the plurality of interconnected computer systems, wherein the selecting step comprises selecting the desired file from the new list of files, and wherein the desired file is retrieved in real-time from the other one of the plurality of interconnected computer systems.

17. The computer-implemented method of claim 10, the information in the desired file is communicated to the user interface for display.

18. The computer-implemented method of claim 10, wherein communicating the information in the desired file comprises downloading the desired file to the user for display of the information within the user interface.

19. A computerized system for providing real-time access to information on a computer system over a network, comprising:
an interface system for serving interface pages over the network from a computer system to a user system;
a login system for receiving login data from a user operating the user system and for retrieving access control permissions for the user based on the login data;
a file display system for presenting to the user in the interface pages a list of files on the computer system the user is authorized to access, wherein the list of files is determined based on the access control permissions;
a selection system for receiving from the user a selection of a desired file from the list of files; and
a file retrieval system for retrieving the desired file in real-time and for communicating information in the desired file to the user.

20. The computerized system of claim 19, wherein the network is the Internet, and wherein the interface pages are served to a browser operated by the user.

21. The computerized system of claim 19, wherein the list of files contains at least one file type selected from the group consisting of a properties file, a configuration file and a log file.

22. The computerized system of claim 19, further comprising a file location system for receiving from the user a selection of a particular location within the desired file, wherein the information communicated to the user is from the particular location.

23. The computerized system of claim 19, further comprising a search system for receiving search queries for searching the desired file from the user.

24. The computerized system of claim 19, wherein the computer system is one of a plurality of computer systems interconnected in a distributed environment.

25. The computerized system of claim 19, wherein the files in the list of files are stored on the computer system.

26. The computerized system of claim 19, wherein the information in the file is displayed within the interface pages.

27. The computerized system of claim 19, wherein the information is communicated by downloading the desired file to the user for display of the information within the interface pages.

28. A program product stored on a recordable medium for providing real-time access to information on a computer system over a network, which when executed, comprises:
program code for serving interface pages over the network from a computer system to a user system;
program code for receiving login data from a user operating the user system and for retrieving access control permissions for the user based on the login data;
program code for presenting to the user in the interface pages a list of files on the computer system the user is authorized to access, wherein the list of files is determined based on the access control permissions;
program code for receiving from the user a selection of a desired file from the list of files; and
program code for retrieving the desired file in real-time and for communicating information in the desired file to the user.

29. The program product of claim 28, wherein the network is the Internet, and wherein the interface pages are served to a browser operated by the user.

30. The program product of claim 28, wherein the list of files contains at least one file type selected from the group consisting of a properties file, a configuration file and a log file.

31. The program product of claim 28, further comprising program code for receiving from the user a selection of a particular location within the desired file, wherein the information communicated to the user is from the particular location.

32. The program product of claim 28, further comprising program code for receiving search queries for searching the desired file from the user.

33. The program product of claim 28, wherein the computer system is one of a plurality of computer systems interconnected in a distributed environment.

34. The program product of claim 28, wherein the files in the list of files are stored on the computer system.

35. The program product of claim 28, wherein the information in the file is displayed within the interface pages.

36. The program product of claim 28, wherein the information is communicated by do wnloading the desired file to the user for display of the information within the interface pages.
